(19) United States
(12) Patent Application Publication
(10) Pub. No.: US 2010/0166103 A1
(43) Pub. Date: Jul. 1, 2010

(54) METHOD AND APPARATUS OF TRANSMITING ENCODED MESSAGE

(76) Inventors: Tom HAREL, Shfaim (IL); Assi JAKOBY, Herzliya (IL)

Correspondence Address: PEARL COHEN ZEDEK LATZER, LLP, 1500 BROADWAY, 12TH FLOOR, NEW YORK, NY, 10036, US

(21) Appl. No.: 12/344,904

(22) Filed: Dec. 29, 2008

(51) Int. Cl. H04L 27/00

(52) U.S. Cl. 375/295

(57) ABSTRACT

A method and apparatus to encode a data message and to transmit the encoded data message is provided. The method may include encoding a data packed with convolution turbo codes that include code polynomials and adding to the code polynomials a desired polynomial, padding the data message with zero bits, diminishing bits that known to the receiver and transmitting the encoded padded data message according to a combined HARQ transmission scheme.

### BACKGROUND OF THE INVENTION

A wireless metropolitan area network (WMAN) may be operated according to an IEEE 802.16 standard and may be referred as WiMAX. In WiMAX communication system a convolutional turbo codes (CTC) channel coding may be used. Furthermore, the present CTC channel coding is not supporting block size that are multiples of 7. The present IEEE 802.16 is not supporting a tradeoff of link performance with a channel throughput.

WiMAX communication devices may use an error control method, Hybrid Automatic repeat-request (HARQ) transmission scheme, to transmit and receive data messages. In this error control method error-detection information (ED) bits such as, for example turbo codes, and forward error correction (FEC) bits are added to data to be transmitted.

In practice, incorrectly received coded data blocks are often stored at the receiver rather than discarded, and when the retransmitted block is received, the two blocks are combined. While it is possible that independently decoded, two given transmissions are not possible to decode error-free, it may happen that the combination of all the previously erroneously received transmissions gives enough information to correctly decode. There are mainly two ways of re-combining in HARQ. The first way may be a chase combining. In this way every retransmission may contain the same information (data and parity bits). The second way may be Incremental redundancy (IR). In this way every retransmission may contain different information than the previous one. At every retransmission the receiver may gain knowledge of extra information.

An example HARQ-IR is High-Speed Downlink Packet Access (HSDPA). According to this example, the data block is first coded with a punctured 1/3 Turbo code, then during each (re)transmission the coded block is usually punctured further (i.e. only a fraction of the coded bits are chosen) and sent. The punctuation pattern used during each (re)transmission is different, so different coded bits are sent at each time.

### BRIEF DESCRIPTION OF TIRE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is an illustration of a portion of a wireless communication system according to exemplary embodiments of the present invention;

FIG. 2 is a flow chart of a method of lowering a code rate of encoded data block, according to exemplary embodiments of the invention;

FIG. 3 is a flow chart diagram of a method of reducing a data block size, according to embodiments of the invention; and

FIG. 4 is a flow chart diagram of a method of bits constellation rearrangement for HARQ transmission scheme, according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals. These algorithmic descriptions and representations may be the techniques used by those skilled in the signal processing arts or/and in wireless communication arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer and/or computing system and/or medium access controller (MAC) and/or communication processor, or similar electronic computing device, that manipulate and/or transform data represented as physical, such as electronic, quantities within the computing system's registers and/or memories into other data similarly represented as physical quantities within the computing system's memories, registers or other such information storage, transmission or the like. In addition, the term “plurality” may be used throughout the specification to describe two or more components, devices, elements, parameters and the like. For example, “plurality of mobile stations” describes two or more mobile stations.

It should be understood that the present invention may be used in a variety of applications. Although the present invention is not limited in this respect, the circuits and techniques disclosed herein may be used in many apparatuses such as communication devices of a radio system. The communication devices intended to be included within the scope of the present invention include, by way of example only, mobile stations, base stations and access points of radio systems such as, for example a wireless local area network (WLAN) which also may be referred as WiFi, a wireless metropolitan area network (WMAN) which also may be referred as WiMAX, a wireless personal area network (WPAN) such as, for example those using Bluetooth™ technology, two-way radio transmitters, digital system transmitters, analog system transmitters, cellular radiotelephone transmitters, digital subscriber lines, long term evolution (LTE) cellular systems and the like.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, assembly language, machine code, or the like.

In accordance with embodiments of the invention, a channel may be a physical transfer medium. The physical transfer medium may be used to transfer signals such as, for example, informative data signals, training signals, pilot signals, sub-carriers signals, preamble signals and the like, that may be modulated by one or more modulation scheme. Furthermore, the channel may be a combination of the physical transfer medium, components of the transmitter and/or the receiver, for example path loss, noise, interference or the like. It should be understood to the skilled artisan that embodiments of the invention may operate with many types of signals, which partially mention above, and the invention is in no way limited to the above mentioned signals.

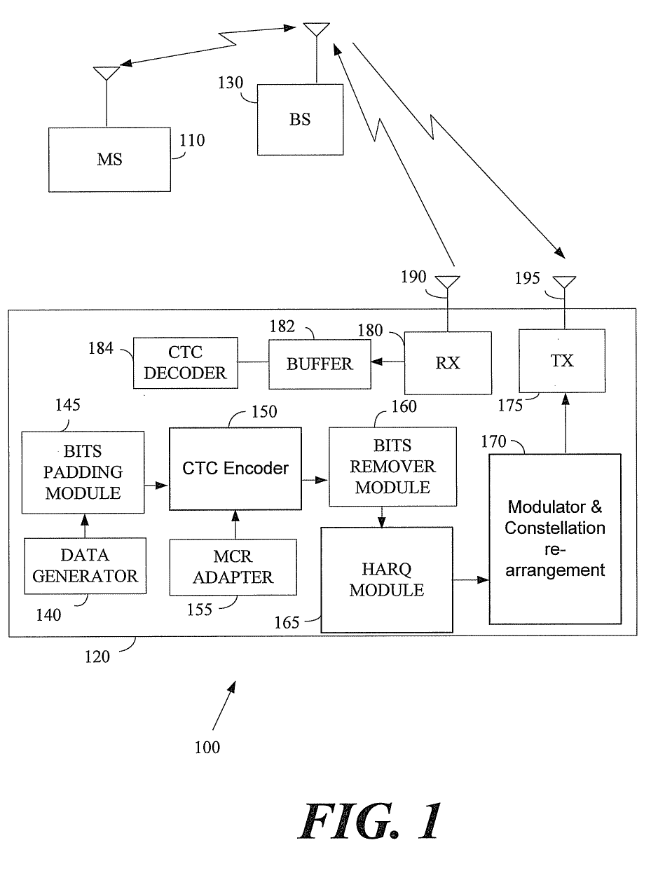

Turning first to FIG. 1, an illustration of a portion of a wireless communication system according to some exemplary embodiments of the present invention is shown. According to this exemplary embodiment of the invention, a wireless communication system 100 may include a WiMAX (e.g., a wireless communication system which operates according IEEE 801.16 standard), an LTE or the like. An exemplary wireless communication system 100 includes mobile stations (MS) 110, 120 and a base station 130. According to one example embodiment, MS 120 may include a data generator 140, a bit padding module 145, a convolution turbo codes (CTC) encoder 150, a mother code rate (MCR) adapter 155, a bit remover module 160, a HARQ module 165, a modulator and constellation rearrangement module 170, a transmitter (TX) 175, a receiver (RX) 180, a buffer 182, a CTC decoder 184 and antennas 190, 195.

Although the scope of the present invention is not limited in this respect, antennas 190, 195 may include a dipole antenna, an omni-directional antenna, an internal antenna, a Yagi antenna, or the like.

According to exemplary embodiments of the invention, a transmitter path may include for example data generator 140, bits padding module 145, CTC encoder 150, MCR adapter 155, bit remover module 160, HARQ module 165, modulator and constellation rearrangement module 170, transmitter (TX) 175 and antenna 195. Receiver (RX) 180, buffer 182, CTC decoder 184 and antenna 190 may be included in a receiver path, although the scope of the present invention is not limited in this respect.

According to embodiments of the invention, a mother code rate may be defined as a ratio between number of information bits to a size of a mother code word, wherein the mother code word includes information bits and parity bits.

According to this exemplary embodiment, data generator 140 may generate a protocol message, a data message, data frames and any other form of data that may be transmitted by TX 175. Data generator 140 may be a software application, a communication processor or the like. Data generator 140 may be implemented by hardware, software and/or any combination of hardware and software. Bit padding module 145 may for example add zero bits to the data message that generates by data generator 140. For examples the padded bits may be added in pairs to message bits in the same position. CTC encoder 150 may encode the padded message by a larger block size selected from a list of different sizes. MCR adapter 154 may adapt the MCR of CTC encoder 150. MCR adapter 154 may provide adapted mother code rate (R_{MC}) according to receiver 180 buffering capability. For example RMC may be 1/2, 1/3 or 1/4 although the scope of the present invention is not limited to this example. CTC encoder 150 and MCR adapter 154 may be implemented by hardware, by software and/or any combination of hardware and software.

According to embodiments of the invention, bits removal module 160 may diminish systematic padding bits that are known at the receiver. Furthermore, bits remover module 160 may diminish parity bits at similar position of a trellis of the encoded message to the pairs of padding bits. Bits removal module 160 may be implemented by hardware, by software, and/or any combination of hardware and software.

According to some embodiments of the invention, HARQ module 165 may operate according to HARQ-IR transmission scheme. HARQ module 165 may select a bit version of the encoded padded data message for transmission. HARQ module 165 may be implemented by hardware, by software, and/or any combination of hardware and software.

Modulator and constellation rearrangement (CoRe) 170 may receive from the HARQ module 165 the encoded padded messages and MCR and channel code rate (RCHAN) parameters and may modulate the message for example, by quadrature amplitude modulation (QAM) or the like, if desired. According to some embodiments of the invention, modulator and CoRe 170 may count the number of times that a bit has been transmitted and select the CoRe version accordingly. For example, bits transmitted even number of times are modulated according to first CoRe version, and bits transmitted odd number of times are modulated according to second CoRe version. Modulator and CoRe 170 may be implemented by hardware, by software, and/or any combination of hardware and software.

According to embodiments of the invention TX 175 may transmit the modulated data message which may be split into several forward error correction (FEC) blocks by data generator 140, through antenna 195, if desired. For example, transmitter 175 may include multiple transmitters that connected to multiple antennas and may transmit the modulated data message according to multiple in multiple out (MIMO) transmission scheme, if desired.

According to some exemplary embodiments of the invention, RX 180 may receive through antenna 190 FEC blocks of the modulated padded message and may store the FEC blocks of the received modulated padded message in buffer 182, if desired. Buffer 182 may also store information bits and metrics. CTC decoder 184 may decode the FEC block by performing a predetermined number of iterations for example, 24 iterations. If CTC decoder 184 may not converge after the predetermined times of iteration, CTC decoder 184 may announce on decoding error and may send a request for retransmission of the error FEC block or the entire message, if desired.

Furthermore, CTC decoder 184 may add the known parity bits to the received data message by setting their metrics to maximum confidence on the padding values. CTC decoder 184 may de-puncture the missed parity bits as erasures (LLR=0) and may apply the normal decoder process for the larger block, if desired.

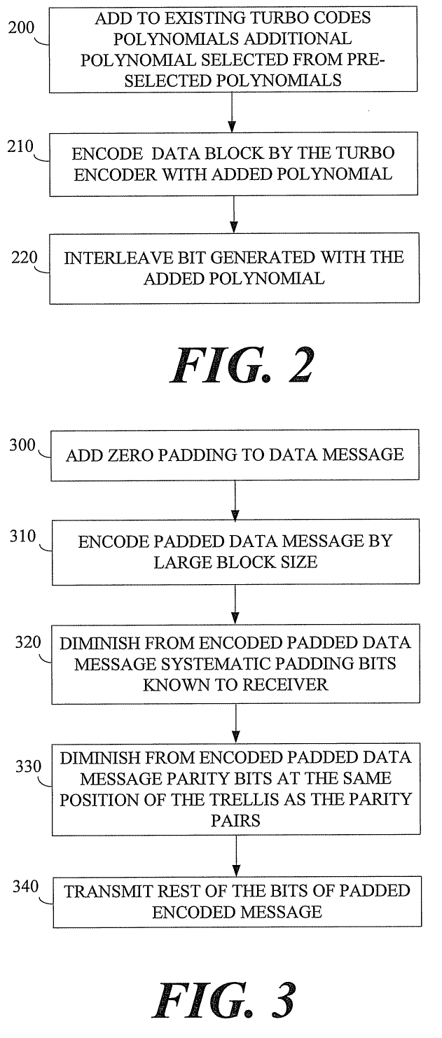

Turning to FIG. 2 a flow chart of a method of lowering a data rate or code rate of encoded data block, according to some exemplary embodiments of the invention is shown. According to this example method, performance of the CTC code may be determined by three components: the underlying convolution code (CC) trellis, code polynomials and the inner interleaver. One embodiment includes for lowering the data rate or rate of a code based on adding additional polynomial/polynomials to an existing code from a set of pre-selected polynomials (e.g., text block 200). A data message with the added polynomial may be encoded by a turbo encoder (text block 210). The encoded bits that generated with the added polynomial may be interleaved (text block 220).

The additional polynomial may be selected from for example 1+D or 1+D̂2 for duo-binary CTC code used with IEEE 802.16 standard. The added polynomial may lower the code rate to for example 1/4, if desired.

Turning to FIG. 3, a flow chart diagram of a method of reducing a data block size, according to some embodiments of the invention is shown. One embodiment may start by adding to a data message zero padding. For example, a data message structure may be defined by IEEE 802.16 standard. The zero bits may be added in pairs to bits in the same positions at the data message (text block 300). The zero bits padded data message may be encoded by a larger block size (text block 310). For example, a data message that contains 70 bits may be encoded with block size of 96 bits.

One embodiment may include puncturing a padded data message of systematic padding bits which are known at a receiver, and puncturing the padded data message of at least a portion of parity bits that are at the same position of parity bits of a trails of the encoded padded data message.

An embodiment may include diminishing from the zero padded and encoded data message (puncture) the systematic padding bits which are known at the receiver (text block 320) and the parity bits that may be at the same position of the trellis as the padding pairs (text block 330). Remaining bits of the padded data message may be transmitted (text block 340), for example according to HARQ transmission scheme, although embodiments of the present invention are not limited to this respect.

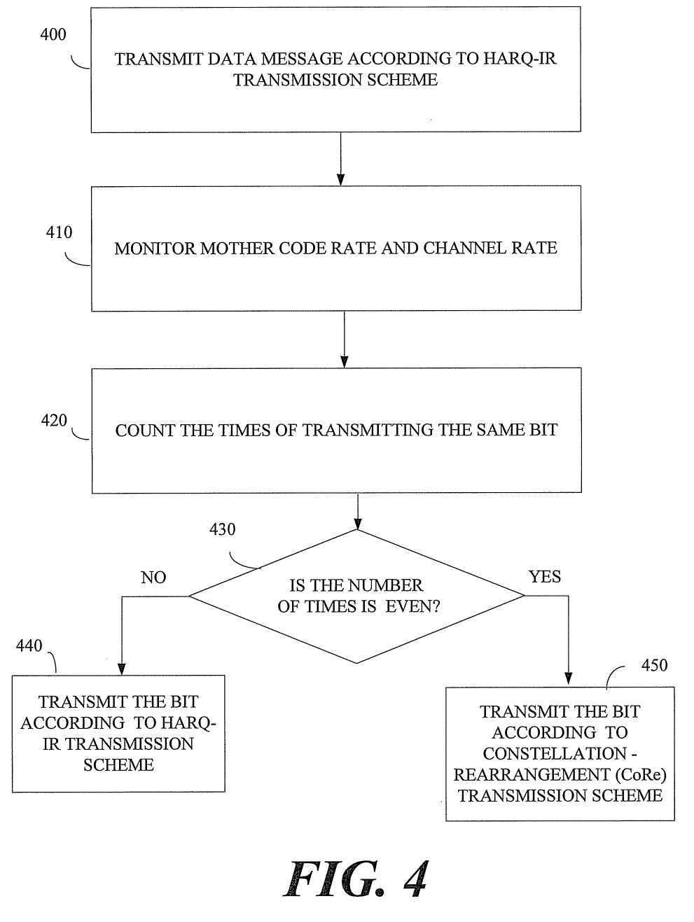

Turning to FIG. 4, a flow chart diagram of a method of bits constellation rearrangement for HARQ transmission scheme, according to some embodiments of the invention is shown. Constellation-Rearrangement (CoRe) for QAM modulated signals and Incremental Redundancy (IR) are partially conflicting methods. While in IR new parity bits are transmitted in a re-transmission, the CoRe is based on re-transmission of the same coded bits with different mapping of bits in the constellation that “equalizes” the protection of the bits.

According to embodiment of the invention, bits of a data message may be transmitted for the first time according to HARQ-IR transmission scheme (text block 400). A mother code rate and a channel rate may be monitored in order to know if some of the bits have been re-transmitted (text block 410). For example, when transmitting with mother-code-rate 1/3, and channel-code-rate 1/2, some bits may be already re-transmitted, although the scope of the present invention is not limited in this respect.

According to this exemplary method, in order to allocate the re-transmitted bits, counting the number of times that each bit has been transmitted (text box 420). If the number of time is an even number e.g., 1, 3, 5 . . . (diamond 430) then the bit may be re-transmitted according to the CoRe transmission scheme (text box 450). If the number of time is not even number (e.g., 2, 4, 6 . . . ) then the bit may be re-transmitted according to IR transmission scheme (text box 440), although the scope of this method is not limited in this respect.

According to embodiment of the invention, bits of transmitting bits of the data message may be transmitted according to HARQ transmission scheme. The bits for transmission may be selected according to an IR transmission scheme and may be modulated with a CoRe version that is adapted according to the number of times that the bits were transmitted in previous transmissions, although the scope of the present invention is not limited in this respect.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of lowering a data rate comprising:
encoding a data message with convolution turbo codes that include code polynomials; and
adding to the code polynomials a desired polynomial.

2. The method of claim 1, wherein adding comprises adding a 1+D polynomial.

3. The method of claim 1, wherein adding comprises adding a 1+D̂2 polynomial.

4. The method of claim 1, comprising:
interleaving bits of added code polynomials; and
transmitting the encoded data message according to Hybrid Automatic repeat-request (HARQ) transmission scheme.

5. The method of claim 1, comprising:
padding said data message with pre-defined bits;
encoding said padded data message;
puncturing said padded data message of systematic padding bits which are known at a receiver;
puncturing said padded data message of at least a portion of parity bits that are at the same position of parity bits of a trails of the encoded padded data message; and
transmitting remaining bits, after the puncturing, of the encoded padded data message.

6. The method of claim 4 wherein transmitting comprises:
transmitting bits of said data message according to a Hybrid Automatic Repeat-request (HARQ) transmission scheme, wherein the bits for transmission are selected according to an Incremental Redundancy (IR) scheme and are modulated with a Constellation-Rearrangement (CoRe) version that is adapted according to the number of times that the bits were transmitted in previous transmissions.

7. The method of claim 6, comprising;
varying a mother code rate according to capability of a receiver and a transmission throughput wherein, the mother code rate is the ratio between the number of information bits to a sum of a number of information bits and an number parity bits.

8. An apparatus comprising:
a convolution turbo codes encoder to add a desired polynomial to code polynomials, encode a data message with turbo code polynomials and to interleave a plurality of bits generated with the desired added polynomial.

9. The apparatus of claim 8, wherein the desired polynomial comprises a 1+D polynomial.

10. The apparatus of claim 8, wherein the desired polynomial comprises a 1+D polynomial.

11. The apparatus of claim 8, comprising:
a transmitter to transmit the encoded data message according to the Hybrid Automatic repeat-request (HARQ) transmission scheme.

12. The apparatus of claim 8, comprising:
a bit padding module to pad said data message with zero bits; and
a bit remover module to diminished from an encoded padded data message systematic padding bits which known at a receive.

13. The apparatus of claim 12, wherein the bit remover module is able to diminish at least a portion parity bits that are at the same position of parity bits of a trails of the encoded padded data message and to provide to the transmitter remaining bits of the encoded padded data message to be transmitted.

14. The apparatus of claim 8, comprising:
a Hybrid Automatic Repeat-request module to transmit bits of the data message according to Incremental Redundancy (HARQ-IR) transmission scheme; and
a modulator and constellation re-arrangement module to count number of times that each bit of the encoded padded data packet has been transmitted and to change the mapping of re-transmitted bits to constellation according to Constellation-Rearrangement (CoRe) transmission scheme.

15. The apparatus of claim 8, comprising;
a mother code rate adapter operably coupled to the turbo encoder to vary a mother code rate of an encoded data message according to number of users.

16. The apparatus of claim 8, comprising:
a receiver to receive the data message
a turbo code decoder to decode the data message and to announce on decoding error if said decoder does not converge in a predetermined number of iterations.

17. A wireless communication system comprising:
a wireless communication device a including a convolution turbo codes encoder to add a desired polynomial to code polynomials, encode a data message with turbo code polynomials and to interleave a plurality of bits generated with the desired added polynomial.

18. The wireless communication system of claim 17, wherein the desired polynomial comprises 1+D polynomial.

19. The wireless communication system of claim 17, wherein the desired polynomial comprises 1+D polynomial.

20. The wireless communication system of claim 17, wherein the wireless communication device comprises:
a transmitter to transmit the encoded data message according to Hybrid Automatic repeat-request (HARQ) transmission scheme.

21. The wireless communication system of claim 17, wherein the wireless communication device comprises:
a bit padding module to pad said data message with zero bits; and
a bit remover module to diminished from an encoded padded data message systematic padding bits which known at a receiver.

22. The wireless communication system of claim 21, wherein the bit remover module is able to diminish at least a portion parity bits that are at the same position of parity bits of a trails of the encoded padded data message and to provide to the transmitter remaining bits of the encoded padded data message to be transmitted.

23. The wireless communication system of claim 17, wherein the wireless communication device comprises:
a Hybrid Automatic Repeat-request module to transmit bits of the data message according to Incremental Redundancy (HARQ-IR) transmission scheme;
a modulator and constellation re-arrangement module to count number of times that each bit of the encoded padded data packet has been transmitted and to change the mapping of re-transmitted bits to constellation according to Constellation-Rearrangement (CoRe) transmission scheme.

24. The wireless communication system of claim 17, wherein the wireless communication device comprises;
a mother code rate adapter operably coupled to the turbo encoder to vary a mother code rate of an encoded data message according to number of users.

25. The wireless communication system of claim 17, wherein the wireless communication device comprises:
a receiver to receive the data message
a turbo code decoder to decode the data message and to announce on decoding error if said decoder does not converge in a predetermined number of iterations.
